(19) United States
(12) Patent Application Publication
(10) Pub. No.: US 2024/0330383 A1
(43) Pub. Date: Oct. 3, 2024

(54) COMMUNITY DIGITAL LIBRARY SYSTEM

(71) Applicant: THE BOARD OF TRUSTEES OF THE UNIVERSITY OF ILLINOIS, Urbana, IL (US)

(72) Inventors: Kevin Ros, Urbana, IL (US); ChengXiang Zhai, Champaign, IL (US)

(21) Appl. No.: 18/623,392

(22) Filed: Apr. 1, 2024

Related U.S. Application Data
(60) Provisional application No. 63/455,896, filed on Mar. 30, 2023.

(51) Int. Cl. G06F 16/9536; G06F 21/62

(52) U.S. Cl. CPC G06F 16/9536; G06F 21/6218

(57) ABSTRACT

A community digital library system includes hardware, connections, and software that include a communities index database configured to host one or more communities. The communities index database indexes information with user input regarding the information for each of the one or more communities. A user interface controls and grants access to the one or more communities with access limited to members of each of the one or more communities. The user interface includes a submission interface configured to allow a user to designate information to be indexed in the one or more communities. The submission interface enables a user to provide the user input regarding the information. An agent is configured to access the information and user input indexed in the communities index database and provide a search function to members of each of the one or more communities. The agent can be a large language model.

### PRIORITY CLAIM AND REFERENCE TO RELATED APPLICATION

The application claims priority under 35 U.S.C. § 119 and all applicable statutes and treaties from prior U.S. provisional application Ser. No. 63/455,896, which was filed Mar. 30, 2023.

### TECHNICAL FIELD

A field of the invention concerns online exploration tools, web browsers and agents that assist users in conducting online exploration.

### BACKGROUND

Modern users understand that efficient online exploration of material is a non-trivial task. Tools exist to save and share information and websites, e.g. bookmarks and comparable tools. However, relationships between different sources of content can be difficult to navigate. Users must discern and navigate through content relationships independently of tools provided to them through typical web browsers or network search tools. When a user is unfamiliar with a topic, that user can easily fail to find relevant information or waste time exploring incorrect directions. The ranking of websites in a given search result list is often influenced by data having little or no basis in content relationship. Search engine optimization techniques and paid rankings further obscure even the most basic relationships from a user. After search results are displayed, no other content relationship is provided excepting the fact that a search produced the list of content results.

Social bookmarking websites allow a user to create a personal archive where users can tag, describe, and save URLs, both publicly and privately. Pinboard is a subscription-based example social bookmarking site. Pinboard offers an archiving service which saves a copy of everything a user bookmarks, and gives a user full-text search of the booked marked cites, while automatically checking accounts for dead links. Pearltrees is another bookmarking website where users also upload their own images and files, as well as create “interest maps”. Pearltrees allows users to collaborate to explore user bookmarks. Reddit allows users to post content and links while allowing other users to vote and comment on the links. Generally, the social bookmarking websites allow users to save and share bookmarks, and permit ratings and annotations on bookmarks. Such sites allow users to benefit from the work of other users to understand a particular content or link, but fail to provide information about relationships of content and link that could aid a user to explore content relationships.

Sites such as Reddit, Twitter, and classroom forums provide no or rudimentary abilities regarding content relationships. For example, if two people post the same link to any of these forums, the posts are unrelated from the platform's perspective. Similar to social bookmarking websites, content itself is described without any information regarding relationships among the content. No rich ability to navigate sequential relationships among content is provided.

Wang et al., U.S. Pat. No. 10,284,512 describes a social networking system that provides a user with a control to share content from an external system. The user can select among sharing parameters specifying destinations that the user can choose between to indicate where the content will be posted within the online system. Content is retrieved from the external system and is transmitted to destinations in the social networking website based at least in part on the sharing parameters. The sharing parameters can indicate which content to share, formatting parameters for specifying how to format the content, and destination parameters indicating particular destinations in the social networking website for the content. The shared content can also be tracked in the social networking website and updated responsive to changes in the external source content in the external system. This improves upon the need for a user to copy and paste information from an external system to a location on the social network. Relationships amount members of the network having similar work, hobby, and educational history can be leveraged to share information. However, content itself is shared without any information regarding relationships among multiple external sources of content.

Alkov et al U.S. Pat. No. 9,397,970 discloses systems that can coordinate deep tagging of media content with community chat postings. A disclosed method monitors a group chat of participants that are co-browsing media content. A token that appears a threshold number of times within a temporal window is identified. A deep tag is created in the media content in association with a portion of the media content played back concurrently with the temporal window. This solves problems with member of a social network having to tediously must recall a desired portion of media content that can be shared and navigate to that portion during playback in order to apply a deep tag. Access to individual external media content is improved, however, the deep tags don't define relationships between different external media content sources.

### SUMMARY OF THE INVENTION

A preferred embodiment provides a community digital library system, comprising hardware, connections, and software that include a communities index database configured to host one or more communities. The communities index database indexes information with user input regarding the information for each of the one or more communities. A user interface controls and grants access to the one or more communities with access limited to members of each of the one or more communities. The user interface includes a submission interface configured to allow a user to designate information to be indexed in the one or more communities. The user submission interface enables a user to provide the user input regarding the information. An agent is configured to access the information and user input indexed in the communities index database and automatically scraped data in the webpages index, and provide a search function to members of each of the one or more communities.

A preferred embodiment provides a browser extension for a community digital library system. The browser extension includes user interfaces to add to and access a communities index database that hosts one or more communities. The communities index database indexes information with user input regarding the information for each of the one or more communities. The user interfaces include a search interface to the communities index database. The browser provides access to an agent configured to access the information and user input indexed in the communities index database and provide a search function to members of each of the one or more communities.

### BRIEF DESCRIPTION OF THE DRAWINGS

FIGS. 1A and 1B respectively show the software organization and software logic diagram of a preferred community digital library system of the invention;

FIG. 2 shows an example community page that can be provided by an interface of the community digital library of FIG. 1;

FIG. 3A shows an example browsing interface for a user that determines if a web page would be useful to a community through the digital community library system of FIG. 1;

FIG. 3B shows that the highlighting by the user of the interface in FIG. 3A opened a browser extension of the digital community library system of FIG. 1;

FIG. 3C shows that a user can enter a user-created title and description and select a community through the browser extension of the digital community library system of FIG. 1;

FIG. 3D shows a community search result page 310, updated to include a submission active box of FIG. 3C in the digital community library system of FIG. 1;

FIG. 3E shows a submission page of the digital community library system of FIG. 1;

FIG. 3F shows an edit layout of the submission page of the digital community library system of FIG. 1;

FIG. 3G shows the submission page during a user update of a submission of the digital community library system of FIG. 1;

FIG. 3H shows the submission page after the user has saved edits to a submission in the digital community library system of FIG. 1;

FIG. 3I shows a creation box for a user authored submission in the digital community library system of FIG. 1;

FIG. 4A shows that highlighting a source of confusion on a web page to allow a user to open an extension of the digital community library system of FIG. 1;

FIG. 4B shows an opened find tab of the extension of FIG. 4A;

FIG. 4C shows a page generated by the digital community library system of FIG. 1 to allow selection of “Generate Answer” by a user;

FIG. 4D shows that beneath questions and generated answers, the system of FIG. 1 presents a list of recommended submissions related to a user's selected context and grouped by what has been submitted by the user or submitted by another community member;

FIG. 4E shows an example search result for “bm25” retrieved for a user by the digital community library system of FIG. 1;

FIG. 4F shows that a search can be performed on the community digital library website, not just in the extension, and that search can also be limited to the community or communities in the digital community library system of FIG. 1;

FIG. 4G shows that a find tab can be used to implement an “Ask in Context” feature via a labelled button in the digital community library system of FIG. 1; and

FIGS. 5A and 5B show that the user interface can provide a user with a visualized overview of the saved content across communities to which the user is a member.

### DETAILED DESCRIPTION OF THE PREFERRED EMBODIMENTS

A preferred embodiment is community digital library system that includes hardware, connections, and software that include a communities index database configured to host one or more communities. A user can be a member of one or more communities. When the user has an information need, the system can query a communities index data base that stores information and context from users. Context is user input regarding information stored and can include commentary and notes about the information. The system can also map the community database index to provide context about logical connections of information and user input in the communities index database.

The communities index database indexes information with user input regarding the information for each of the one or more communities. A user interface controls and grants access to the one or more communities with access limited to members of each of the one or more communities. user submission interface is configured to allow a user to designate information to be indexed in the one or more communities. The user interface includes a submission interface that enables a user to provide the user input regarding the information. The user interface is preferably configured to accept user submissions from the browser extension and the website. An agent is configured to access the information and user input indexed in the communities index database and provide a search function to members of each of the one or more communities. The agent preferably provides automatic search results and generated questions through the extension in response to a selection of a portion of a web page by the user. The automatic search results are preferably provided by the agent via a search of the communities index database. The agent preferably accesses stored information about users, including submissions and user behaviors, to personalize search results and generated questions for each of the users.

A preferred system provides options via the user interface for a user to select portions of a web page to cause the agent to provide automatic search results and generated questions through an extension, wherein the automatic search results are provided from the communities index, wherein the user interface is further configured to allow the user to accept the automatic search results or conduct further searching of the communities index and the web. The user interface is preferably configured to provides a community search, which can be limited communities index database to user submissions or particular communities from among the one or more communities.

A social network provides members an ability to communicate and interact with other members of the social network. Communities can be formed in a social network when members add connections to a number of other members to whom they desire to be connected. In other contexts, communities can be limited and formed of members that belong to a common educational, social or work group. For example, students in a class or college within a university can be grouped as a community on a social network. Such a community can be formed automatically by the social network based on common characteristics of the members, e.g., members who are students in the same 300 level literature class, or professors who are in the college of electrical engineering. Members of a school marching band can automatically be added to a community. Artisans will appreciate that many other communities can be automatically or user-created in a social network based upon common experiences, pursuits, education, geography, workplace, school place, volunteer groups, etc.

A social network including such user communities can be implemented via a website that interacts with members at client computing devices through a web-based interface. Such a social network with user communities can also be realized through one or more servers that communicate with clients using various client and server applications (e.g., non-web-based applications). A social networking system can also be implemented as a peer-to-peer system with peer-to-peer applications running on the clients that allow members to communicate and perform other functions.

Artisans will appreciate that embodiments of the present invention lend themselves well to practice in the form of computer program products. Accordingly, it will be appreciated that embodiments of the present invention may comprise computer program products comprising computer executable instructions stored on a non-transitory computer readable medium that, when executed, cause a computer to undertake methods according to the present invention, or a computer configured to carry out such methods. The executable instructions may comprise computer program language instructions that have been compiled into a machine-readable format. The non-transitory computer-readable medium may comprise, by way of example, a magnetic, optical, signal-based, and/or circuitry medium useful for storing data. The instructions may be downloaded entirely or in part from a networked computer. Also, it will be appreciated that the term “computer” as used herein is intended to broadly refer to any machine capable of reading and executing recorded instructions. It will also be understood that results of methods of the present invention may be displayed on one or more monitors or displays (e.g., as text, graphics, charts, code, etc.), printed on suitable media, stored in appropriate memory or storage, etc.

Preferred embodiments of the invention will now be discussed with respect to experiments and drawings. Broader aspects of the invention will be understood by artisans in view of the general knowledge in the art and the description of the experiments that follows.

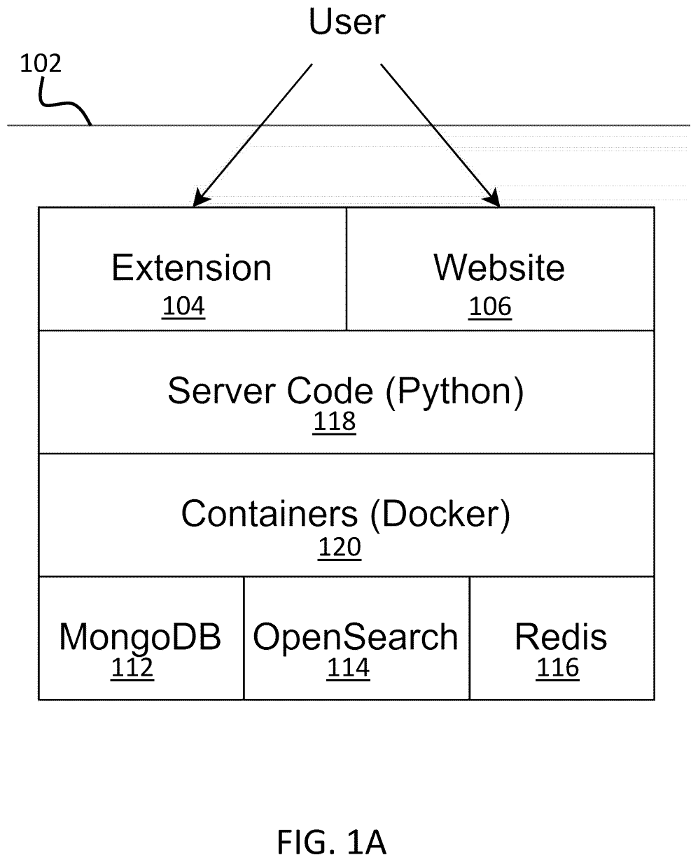

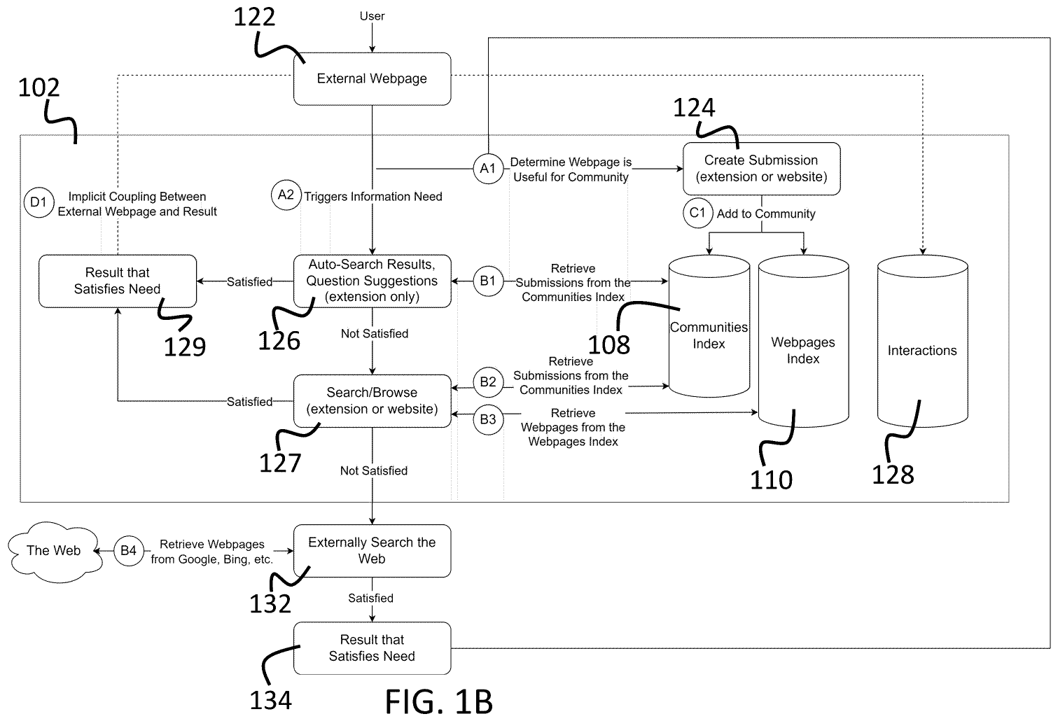

FIGS. 1A and 1B respectively show software organization and software logic diagram of a preferred community digital library system 102. The system 102 preferably includes two user-facing components, a browser extension 104 and a website 106. A communities index 108 and a webpages index 110 are stored in a database 112 and search index 114 and cached in a cache 116. User interactions are also stored in the database 112. Server code 118 and a registry 120 provide an interface between the extension 104/website 106 and the database 112, webpage index 114 and cache 116.

FIG. 1B illustrates software logic operation when a user is conducting an online task and is browsing a public, private or system-generated website 122 (“external” label distinguishes from the system website 106). In step A1, the user finds a webpage to be useful for a community. For example, the webpage 122 helps explain a concept relevant to a course community. The user can create a submission 124 using either the system browser extension 104 or the website 106. Next, step Cl allows the user to submit their created submission 124 to a selected community that that user is admitted as a member. The submission 124 is then saved to the selected community in a user's communities index 108.

If the submission's source URL (i.e., the URL of webpage 122) is public, then the webpage is scraped, and then the scraped webpage is indexed in the webpages index 110, In A2, the webpage triggers an information need for the user (i.e., they encounter an unknown word or an unfamiliar topic). The user can then open the extension 104 on that webpage to see automatic search results and generated questions relating to the user's selected context generated by an agent 126. In B1, the context of the webpage (i.e., the highlighted text) are used by the agent 126 to search a user's communities and retrieve results from the communities index 108. If the retrieved results are determined to satisfy 129 the user's information need, then the process is complete. The system 102 the uses the database 112 to record interactions 128 of the entire process (step D1), which then saves the coupling of the result that satisfies the need with the webpage 122 into an interactions database 128, which is a portion of the database 112.

If the retrieved results do not satisfy the user's information need, then the user can use an agent 127 to search or browse the system 102 directly using either the browser extension 104 or the website 106. Agents 126 and 127 leverage historical interactions 128 along with a user's submissions 108 to provide the user with personalized search results and generated questions. This can take place in either the extension 104 or the website 106. These search and browsing results come from both the communities index 108 via step B2, and from the indexed webpages 110 via step B3. If any of these results satisfy 129 the user's information need, step D1 is repeated. If the retrieved results from communities index 108 and webpages index 110, which are served from index 114 and cached in cache 116, do not satisfy the user's information need, then the user can turn to tools external to the system 102 searching and browsing 132 the general internet. Once the user finds a result 134 via search and browsing 132 satisfies their need, the user can repeat A1 to submit the result to the communities index.

With the system 102, a user starts with a community digital graphical user interface via the website 106 that provides the user with access to a community or communities to which the user has been admitted as a member. The website interface can also be in the form of an app on a mobile device, tablet, or personal computer. The interface includes controls to ensure that the user is part of or can join a community or communities hosted by the system 102. The interface can provide the capability for a user to create or join a community. A community is an individual or group of people having a common interest or connection, and the system 102 forms a community library where information can be saved and organized by the user(s) in the community via the database 112, search index 114 and cache 116. Any number of people can be in a community, from a single person to an entire classroom, an entire college, an entire office, or any other group. Every member of a community has access through the system 102 to all content submitted to that community.

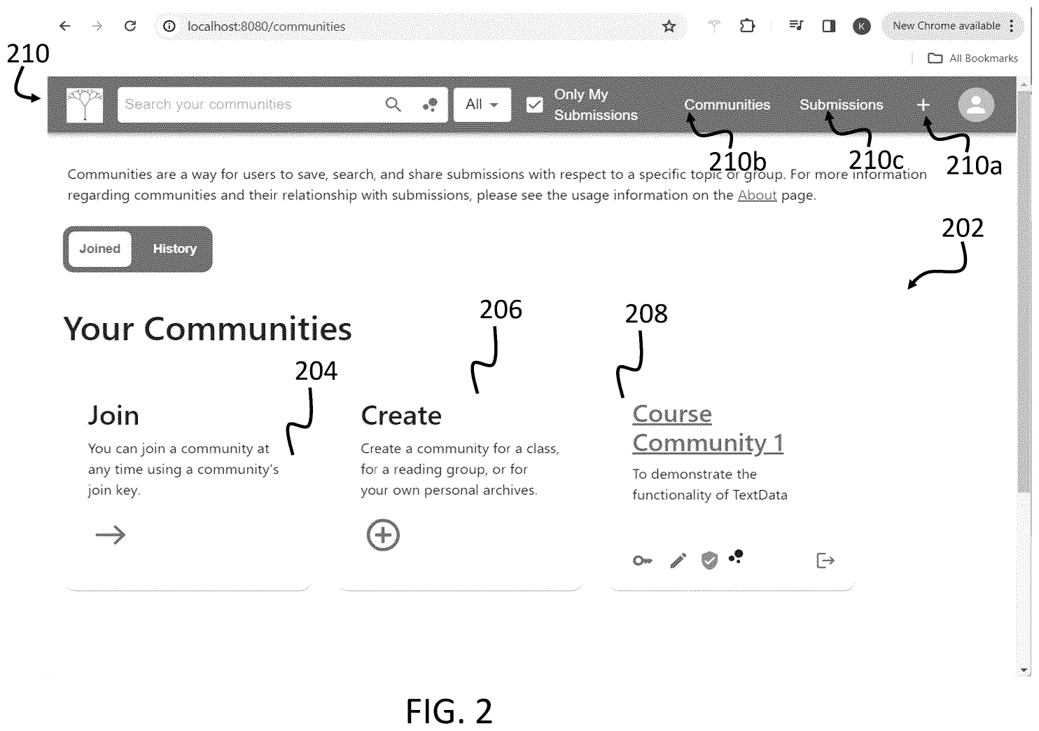

FIG. 2 shows an example community page 202 that can be provided by the system to users of a community via the website 106. The example page 202 is through a Chrome Web Browser. The community page 202 includes graphical links for joining 204, creating 206 and navigating 208 to an existing community that a user has joined. In the example of FIG. 2A, the existing community is that of a course. A header bar 210 provides community search, which can be limited to the user submissions or particular communities. A submission can be created through the header bar (plus button 210a). And a user's communities and own submissions can be viewed by clicking the respective communities 210b and submissions 210c buttons.

Following creation, joining or accessing of a previously joined community, a user can now make submissions to that community in step A1 (FIG. 1B). A submission preferably consists of a title, a markdown-based description, and an optional source URL. The inclusion of a source URL is used for referencing an external webpage (just like a bookmark), whereas the exclusion of a source URL is used to create stand-alone note pages independently of any external source.

In a preferred system consistent with the system 102, to create a submission, the user can use either the system website 106 or the browser extension 104, which has been implemented in an example community digital library via a Chrome Extension. A source URL is automatically included when the user creates a submission with the Chrome Extension 104 and is optional when creating one via the website 106. The extension 104 can be opened by clicking an extension icon after pinning it to the browser window, or via a user-specified hotkey combination (e.g., Alt-Q). The hotkey functionality is set via Chrome or another browser, not via the extension itself.

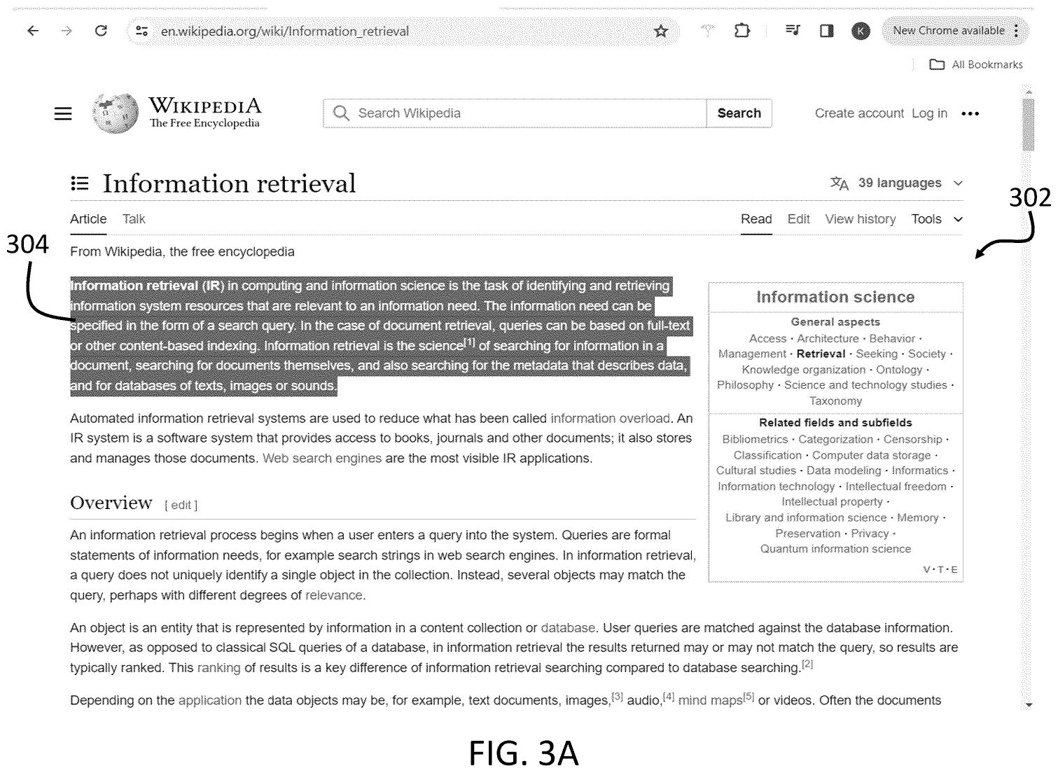

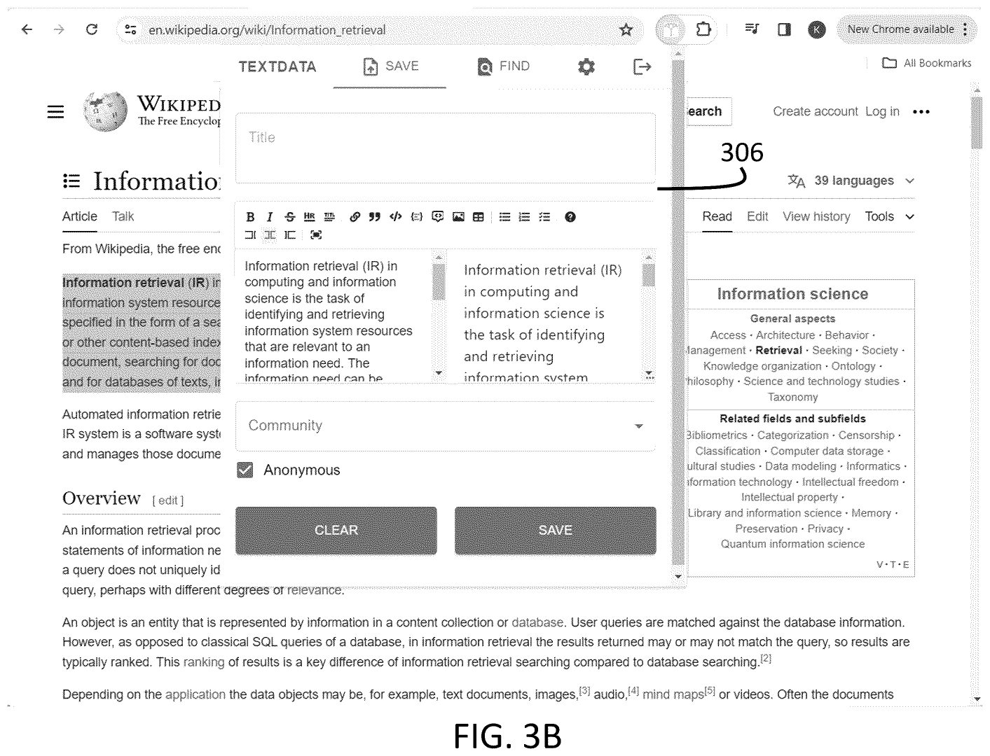

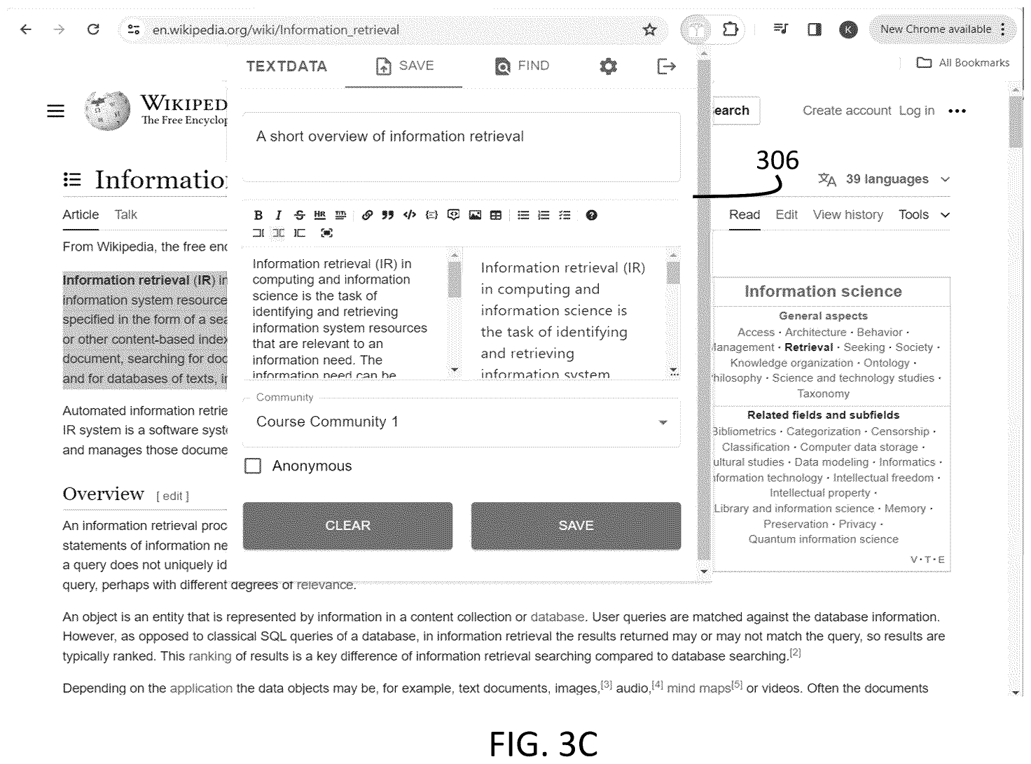

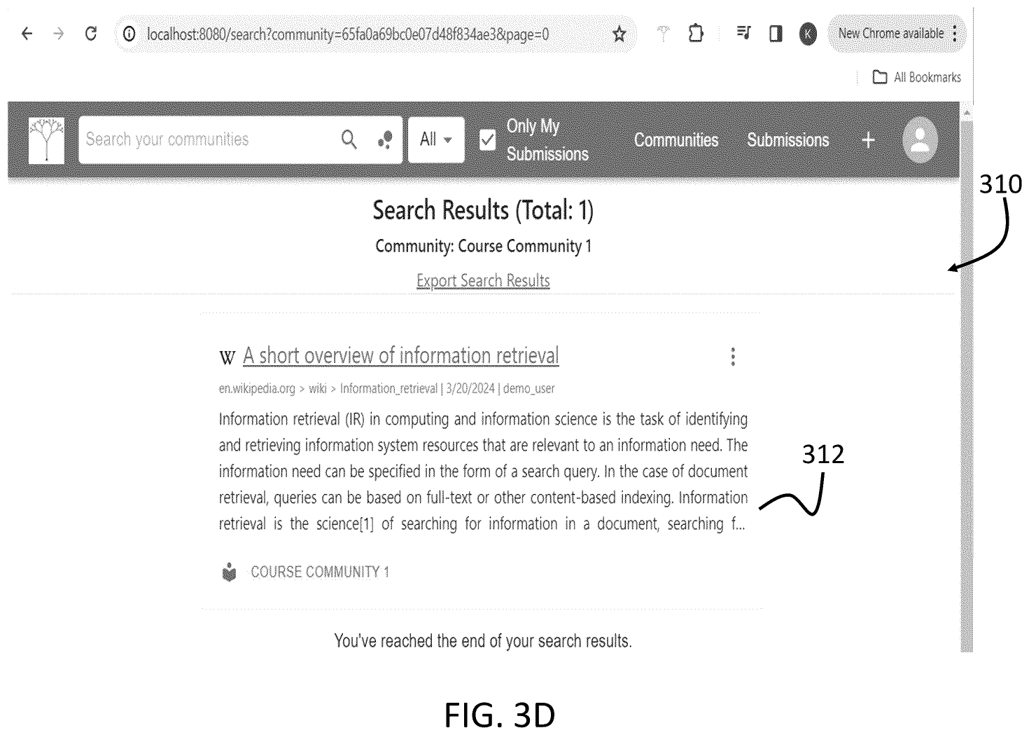

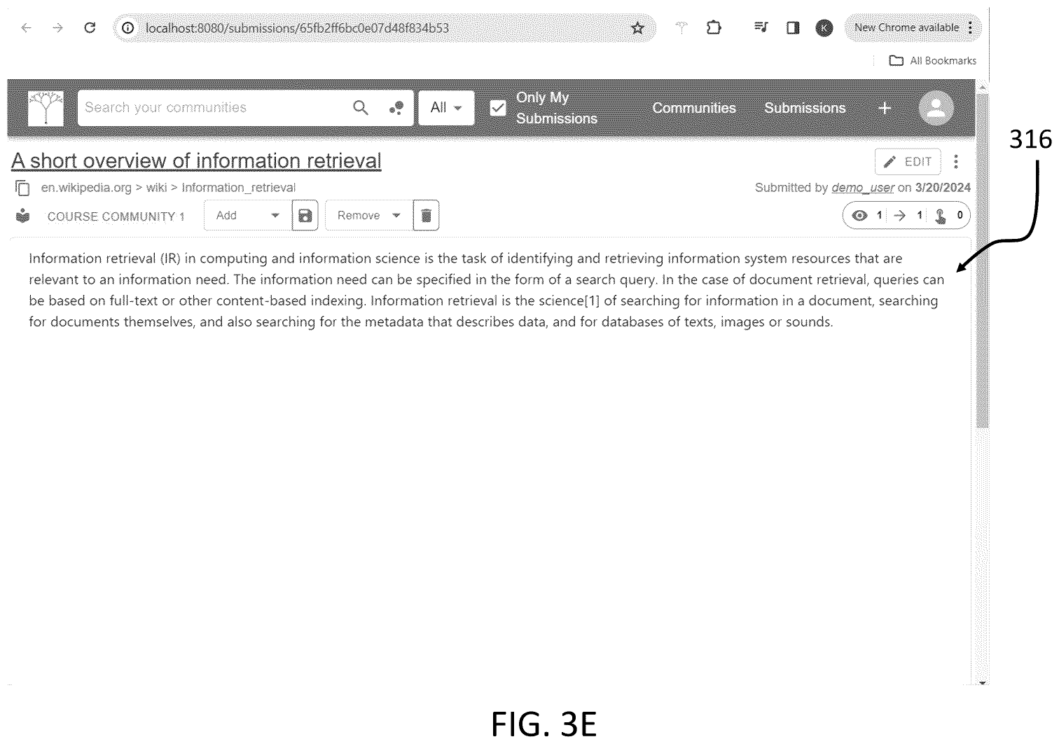

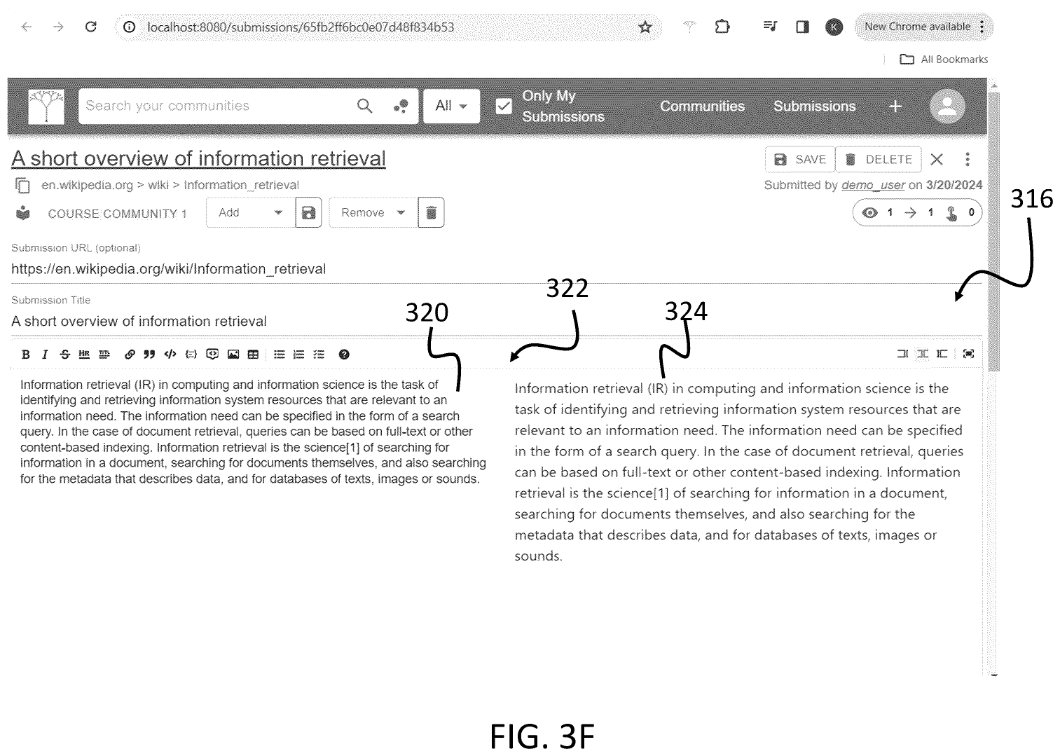

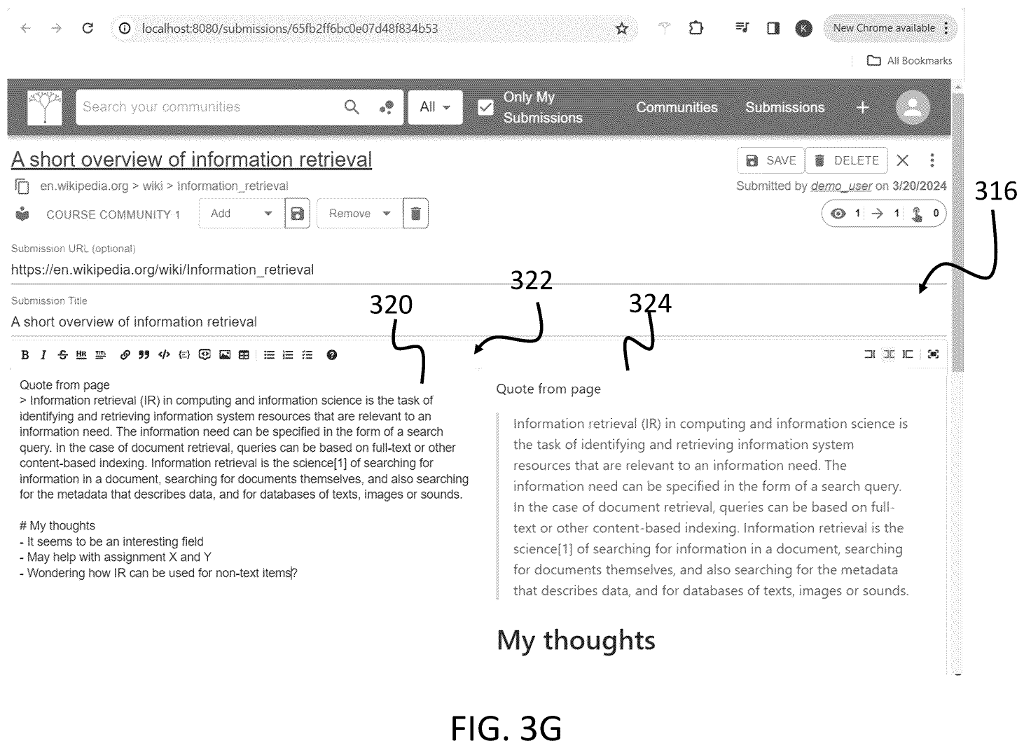

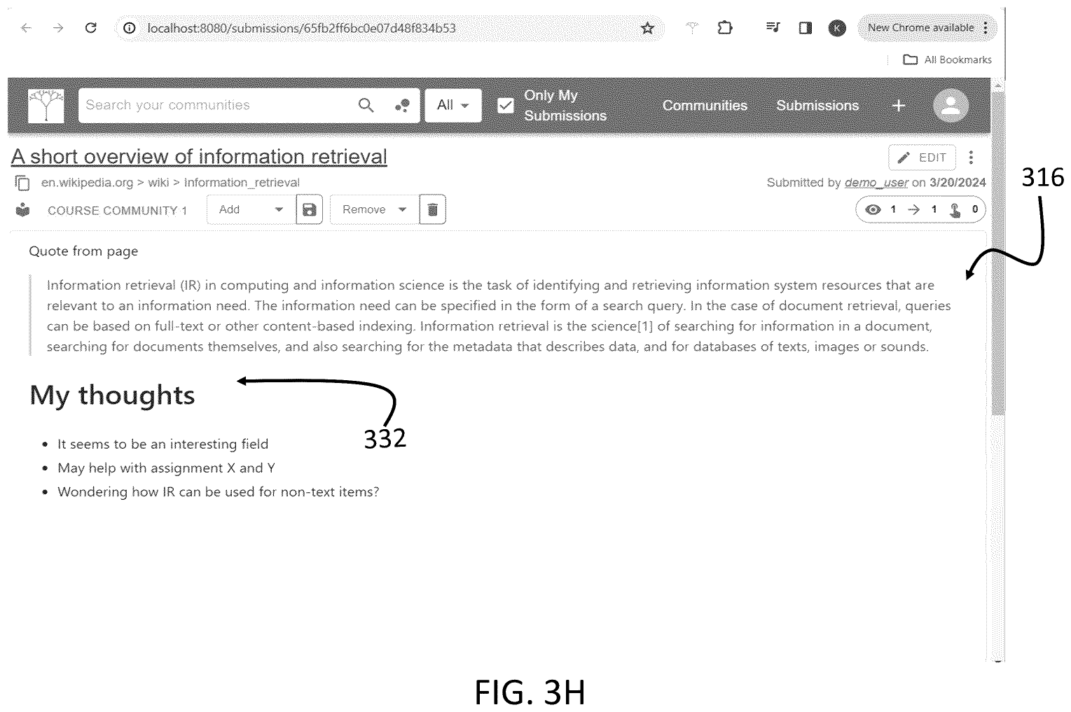

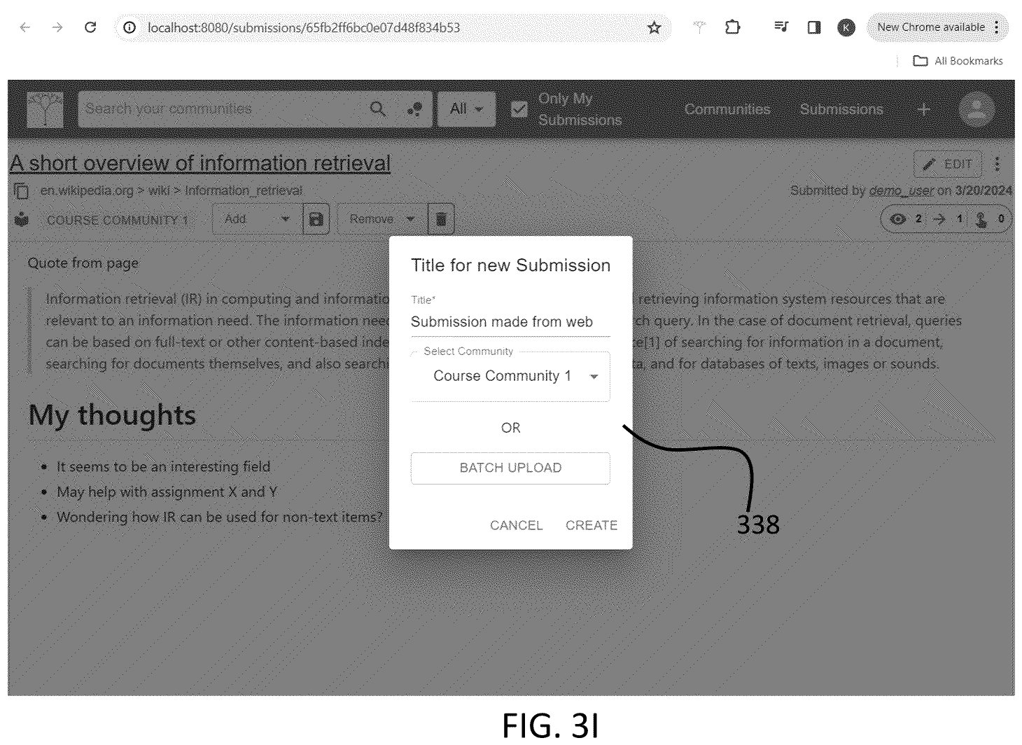

FIG. 3A shows an example browsing by a user that determines a web 102, e.g. the Course Community 1 shown in the navigation button 208 of FIG. 2. A user creates a highlighted portion 304 of the web page 302.

FIG. 3B shows that the highlighting 304 by the user opened a browser extension 306 for the system 102. The extension 306 auto-populates a description field with the highlighted text, if present.

FIG. 3C shows that the user can enter a user-created title, edit the description and select the community through the extension 306, as shown in FIG. 3C. The extension can include an “Anonymous” toggle that includes or excludes the user's username on the submission for other community members to see. The extension 306 does not require the user to enter the URL of the webpage 302, as this is already captured by the extension 306 upon navigation of the user to the webpage 302. After the user fills out the title, description (if needed), and selects a community this completes a step of describing usefulness 106 (FIG. 1), the user can click “Save”, which will save the submission to the respective community. The community is stored in the database 112 (as the communities index 108).

FIG. 3D shows a community search result page 310, updated to include a submission active box 312 discussed in FIG. 3C. The submission active box 312 have a title and description created by the user in FIG. 3C via the extension 306. Clicking the hyperlinked title in the submission active box 312 will bring the user to the Wikipedia page submitted in FIGS. 3B and 3C, but clicking anywhere else on submission active box 312 will bring the user to a submission page of the community digital library system 102.

FIG. 3E shows a submission page 316 of the community digital library system 102. The submission page 316 includes an edit button that allows a creator of the submission to edit the submission. Clicking the “Edit” button at the top of the window toggles to the edit layout of the submission page.

FIG. 3F shows an edit layout of the submission page 316. The edit layout of the submission page 316 allows a user to update the title, the markdown-based description, change its anonymity, and delete the submission. Note that the user can remove the URL, and then the submission will become a stand-alone note page. A left-half edit portion 320 of a description box 322 is where the user can enter their changes, and a right-half preview portion 324 of the description box 322 is where a markdown preview is rendered.

FIG. 3G shows the submission page 316 during a user update of a submission. The user was adding “my thoughts” regarding the quote of the submission via the edit portion 320, which shows a preview of how the submission active box 312 will be changed in the preview portion.

FIG. 3H shows the submission page 316 after the user has saved edits to a submission. The system 102 creates a clear heading section 332 that shows user input, which appears below the heading section 332.

FIG. 3I shows a creation box 338 for a user authored submission. The page 338 is accessed by clicking a “+” sign in the search bar 210 (FIG. 2). This creation box allows users to add submissions to communities and continuously update their content to reflect the submission's utility, both in the community and with respect to other submissions. The creation box includes a pull down for community selection (when the user belongs to more than one community), a title entry portion, or a button to batch upload, which allows a user make multiple submissions at once. The uploaded file should contain a list of (URL, Title, Description) JSON tuples, and each tuple is then added to the user-selected community.

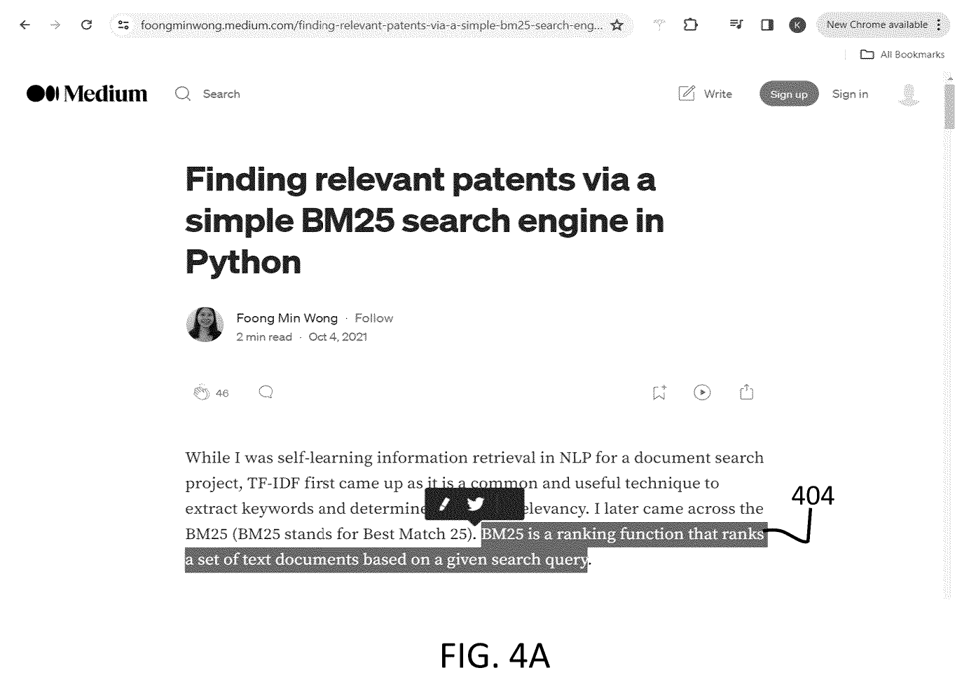

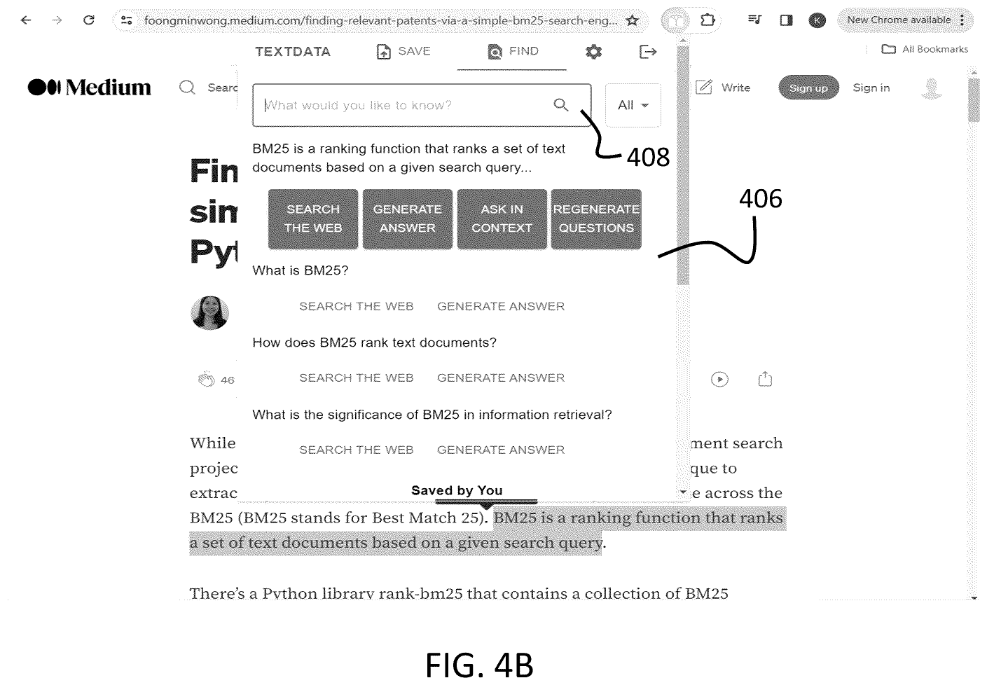

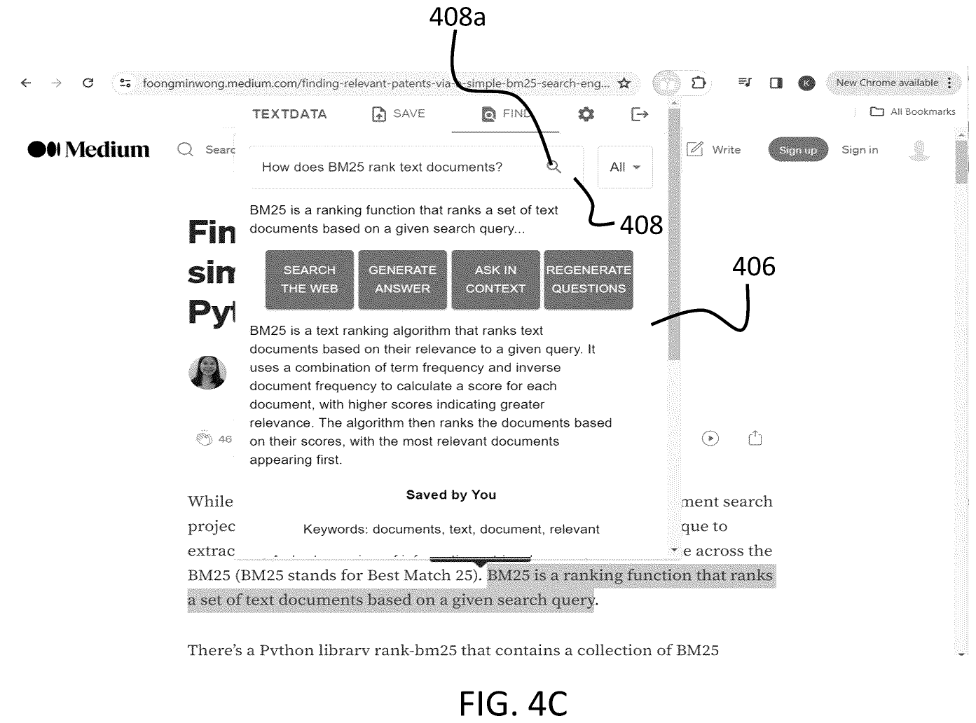

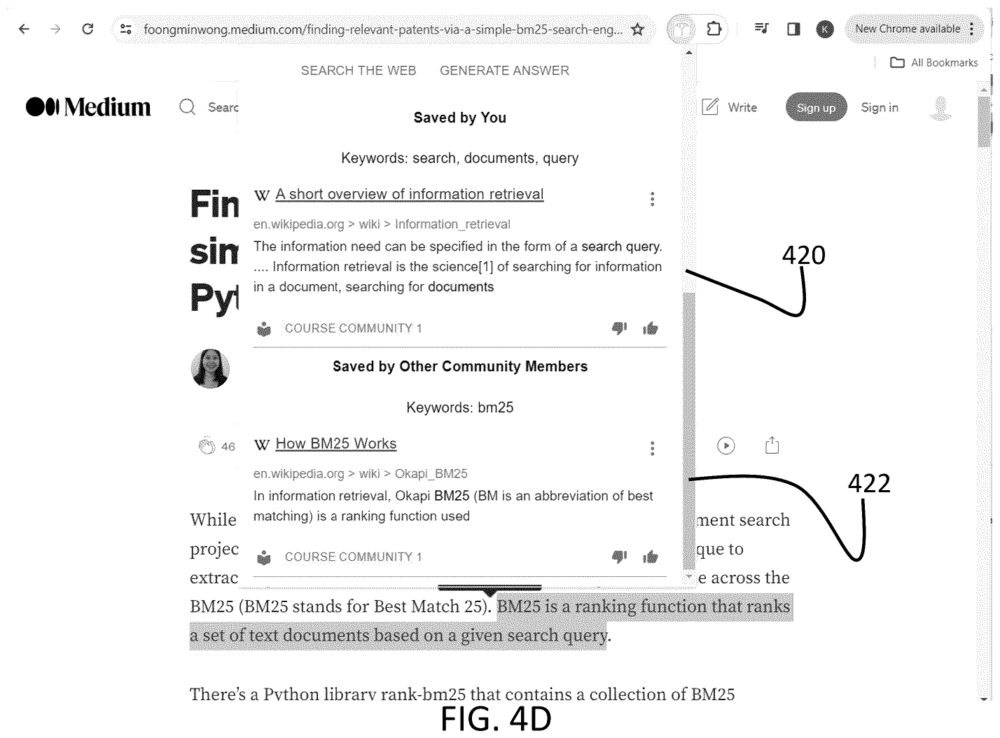

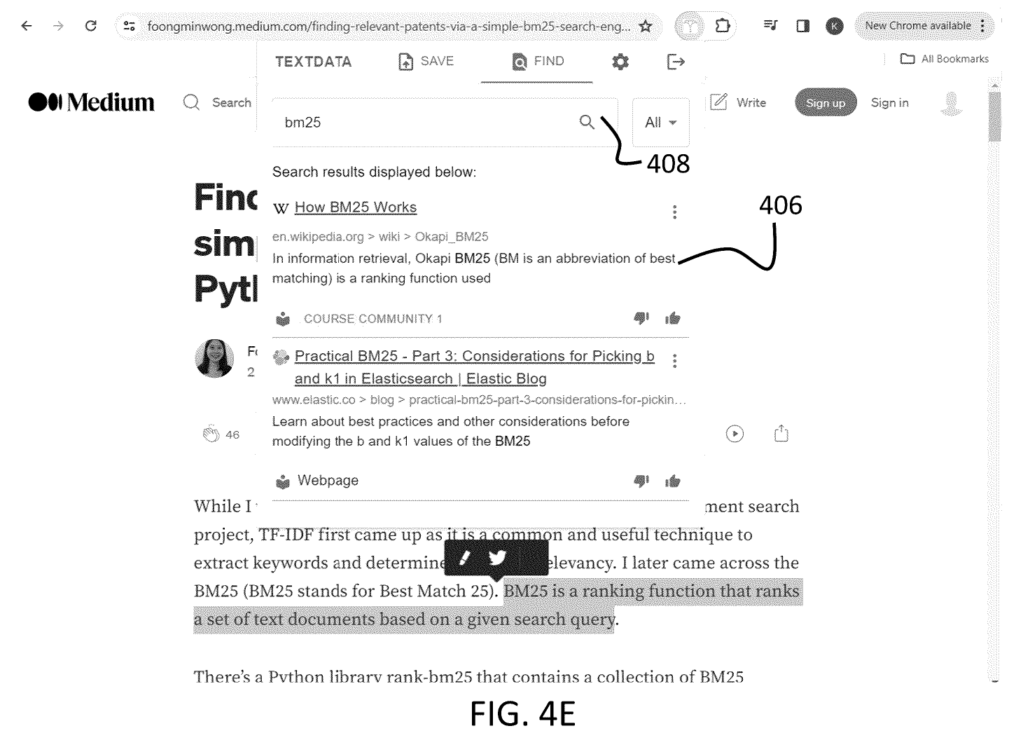

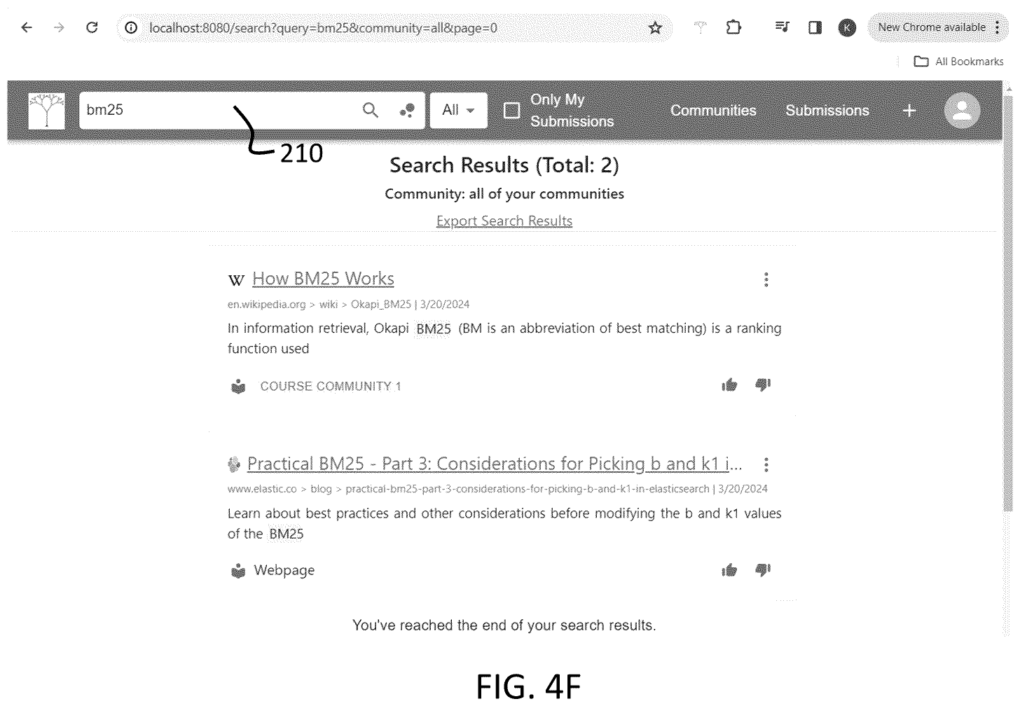

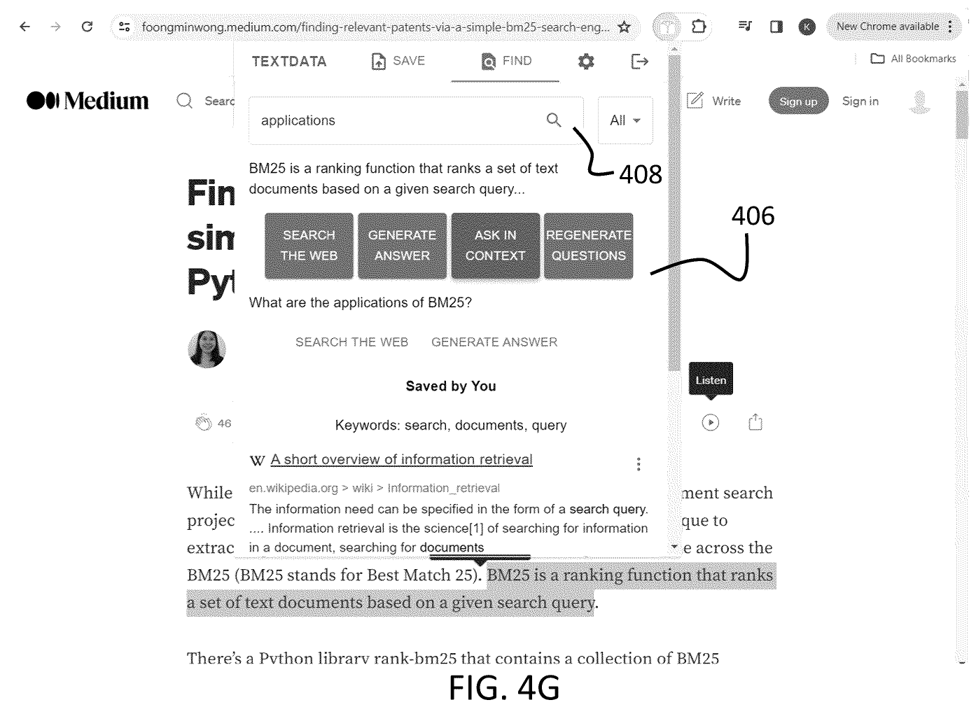

Once the communities index 108 has been established with submissions, the system 102 can deliver content from the index 108 when users look for information in new and different contexts. A community user has an information need in step A2. As an example, suppose the user is viewing a new webpage about search engines in python and comes across an unknown term or concept (in this case, BM25). This is shown in FIG. 4A.

FIG. 4A shows that highlighting 404 a source of confusion allow a user to open the extension 306 to a find tab 406, shown in FIG. 4B. The extension 104 uses the agent 126 (FIG. 1) to generate questions relating to the source of confusion, and the extension 104 queries the communities index 108 to retrieve automated search results. A preferred agent is a large language model, which in step B1 generates predicted questions and automated search results.

An example system consistent with FIGS. 1A and 1B uses the Vicuna large language model, which is an open-source generative language model from LMSYS dot ORG. For each of these questions, the user has two options: click “Search the Web” link or “Generate Answer” link. The former will open a new tab and search the question on Google. The second will generate a paragraph of text in the extension answering the question. The answer is again generated by the Vicuna language model. For example, clicking the second question's “Generate Answer” will display the page shown in FIG. 4C.

FIG. 4D shows that beneath the questions and generated answers, the system 102 presents a list of recommended submissions 420 related to the user's selected context and grouped by what has been submitted by the user or submitted by another community member. Each submission in the list 420 is active, with links leading to web sites and other portions of the submissions leading to information in the communities index 108. To retrieve the recommended submissions 420, the keywords are first extracted from the selected text using an agent, such as TextBlob test processing. Then, these keywords are used as a query over a user's communities in the communities index 108 (FIG. 1B). The submissions are scored using an agent, such as BM25 in OpenSearch.

Step B2 in FIG. 1B provides the user an opportunity to conduct a user-specified search by query 112. A user enters a full question into a search bar 408 of the find tab 406, and then either clicks “Search the Web” or “Generate Answer” buttons. This provides the user with the same functionality as described above and provides additional flexibility to specify a full question instead of relying on a predicted one. Additionally, the user can enter a query and click a search icon 408a in the search bar 408, and this will search their communities in the communities index 108 and webpages index 110 (FIG. 1B) for submissions matching the query. An example search result for “bm25” is shown in FIG. 4E. A preferred engine uses OpenSearch as the webpages index 110 to score submissions. FIG. 4E also shows the presence of “Webpage” results, which are scraped source URLs available to all users permitted to search a community or communities in the communities index 108 (FIG. 1B).

FIG. 4F shows that a search can also be limited to the community or communities in the communities index 108 (FIG. 1B). The “All” button in the website header, directly to the right of the search bar, lets a user select a community to restrict their search to that selected community. The user uses the main search bar 210 to conduct the search in the community by first selecting the All dropdown, which presents a list of communities. The user clicks a community, then clicks the search icon in 210 or presses enter. This will then search the user's query over the selected community or communities only.

FIG. 4G shows that the find tab 406 can be used to implement an “Ask in Context” feature via a labelled button. A user can type a partial query, and the system 102 will combine the partial query and the context into full questions. For example, suppose the user just types “applications” and clicks the button. The questions are generated by prompting Vicuna, as already described question generation techniques. After generating the question(s), the user will then be able to search the web or generate an answer as before.

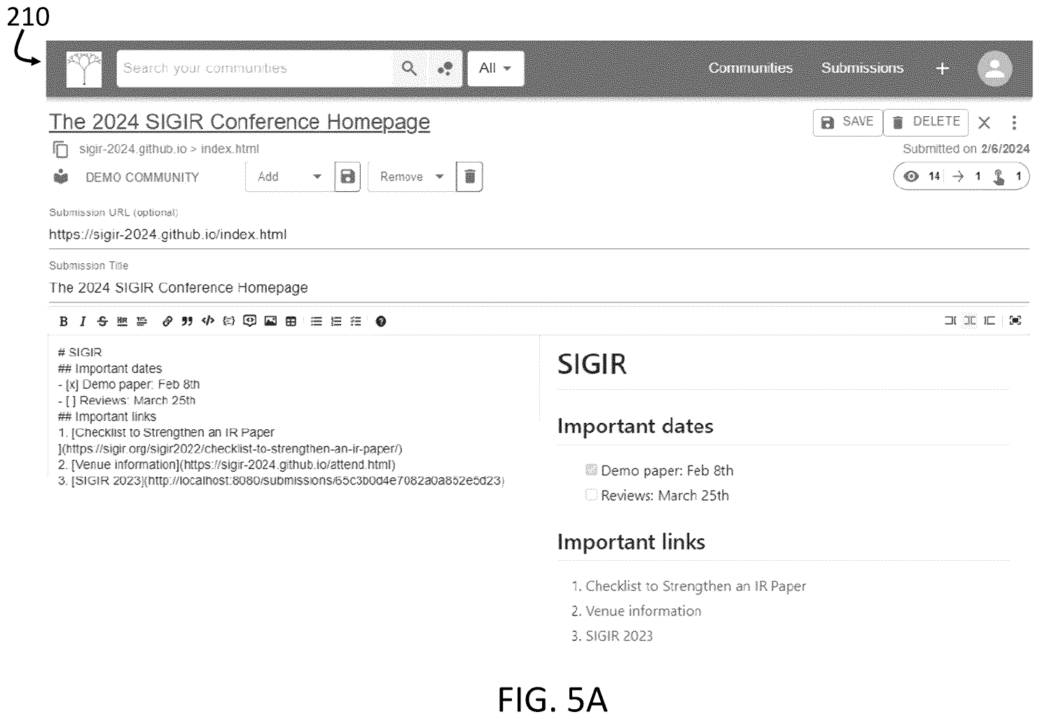

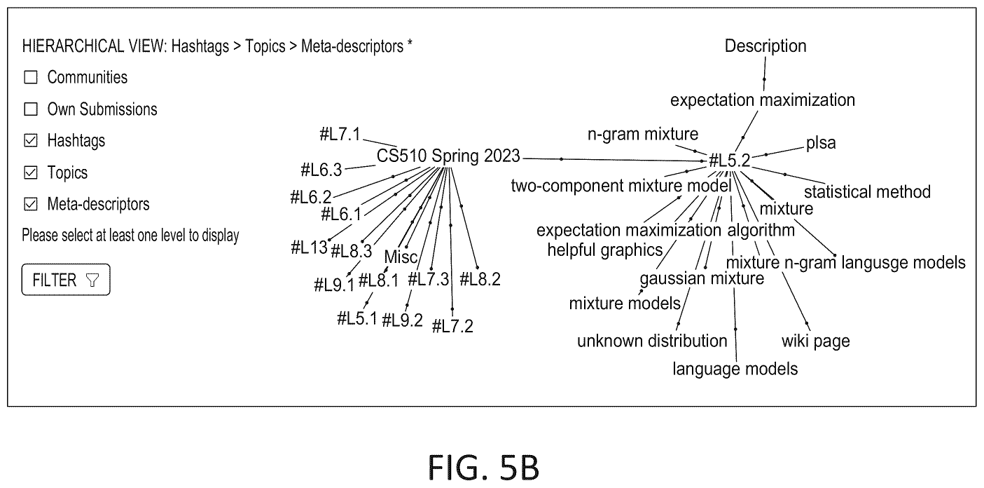

FIG. 5A shows that a user can make and view connections among submissions that are linked in the community index 108. When a submission is linked in the main body of another submission (e.g., “SIGIR 2023” in FIG. 5A, the last “Important Link”), we consider this a “Mention”. To quickly create a mention, a user can type a search query between two square bracket pairs (e.g., “[sigir]”) in the markdown description field (submission description edit field 320 FIG. 3G). The system 102 will then quickly search over all titles in the user's communities through communities index 108 and return the top matches. The user can select one of the titles, and the submission that corresponds to the selected title will be automatically hyperlinked in the description, replacing the bracketed query.

FIG. 5B shows a search results visualization screen presented to a user after conducting a search in discussed in FIG. 5A. From the “CS510 Spring 2023” community, the hashtag “#L5.2 is selected. Then, the topic “expectation maximization” is selected, showing a single meta-descriptor, “Description”. Clicking this will open up a side panel with the corresponding submission(s). that describe expectation maximization.

FIGS. 5A and 5B provide a user with a visualized overview of the saved content across communities to which the user is a member, which is especially helpful when the content is saved via collaboration of a group of users, as some of the submitted content may not be known to others. In testing a system consistent with the system 102 with a class community, we observed that many submission titles and descriptions shared a common structure: they often included a lecture hashtag (per the assignment), a topic (e.g., “bm25”, “language model”), and a meta-descriptor (e.g., “example”, “explanation”, “implementation”). To visualize the structures, the system 102 needs to be able to quickly ex-tract hashtags, keywords, and meta-descriptors from any given submission. A prototype system performed a simple regex search to extract the hashtags, as the hashtags were explicitly denoted in most submissions. For the meta-descriptors, we observed that most fell into one of a handful of general categories: Description, Comparison, Paper, Example, Intuition, Tutorial, Theory, Video, and Miscellaneous. Through this it was possible to define an explicit mapping from each category to a small set of terms, and we checked to see if any particular stemmed meta-descriptor mapped term occurred in a submission. We validated this approach on a hand-labeled subset of submissions made to this course community and found that 91% of the submissions were labeled correctly.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A community digital library system, comprising hardware, connections, and software that comprise:
a communities index database configured to host one or more communities, wherein the communities index database indexes information with user input regarding the information for each of the one or more communities;
a user interface that controls and grants access to the one or more communities with access limited to members of each of the one or more communities, wherein the user interface comprises a submission interface configured to allow a user to designate information to be indexed in the one or more communities, wherein the submission interface enables a user to provide the user input regarding the information; and
an agent configured to access the information and user input indexed in the communities index database and provide a search function to members of each of the one or more communities.

2. The community digital library system of claim 1, wherein a search function of the agent provides access to the web in addition to the information and user input indexed in the communities index database.

3. The community digital library system of claim 1, wherein the user interface comprises a browser extension and a website.

4. The community digital library system of claim 3, wherein the user interface is configured to accept user submissions from the browser extension and the website.

5. The community digital library system of claim 3, wherein the agent provides automatic search results and generated questions through the extension in response to a selection of a portion of a web page by the user.

6. The community digital library system of claim 5, wherein the automatic search results are provided by the agent via a search of the communities index database.

7. The community digital library system of claim 5, wherein the user interface is configured to permit a user to indicate satisfaction of automatic search result, the system further comprising an interactions database that saves coupling of results that satisfy user needs with the web page.

8. The community digital library system of claim 1, wherein the user interface is configured to permit a user to indicate satisfaction of an automatic search result provided by the agent, the system further comprising an interactions database that saves coupling of results that satisfy user needs with a web page viewed by a user that provided the automatic search result.

9. The community digital library system of claim 1, providing options via the user interface for a user to select portions of a web page to cause the agent to provide automatic search results and generated questions through an extension, wherein the automatic search results are provided from the communities index, wherein the user interface is further configured to allow the user to accept the automatic search results or conduct further searching of the communities index and the web.

10. The community digital library system of claim 1, comprising a search index and a cache configured to index the communities index database.

11. The community digital library system of claim 1, wherein the user interface is configured to provides a community search, which can be limited communities index database to user submissions or particular communities from among the one or more communities.

12. The community digital library system of claim 1, wherein the user interface comprises a browser extension, wherein the extension automatically captures a URL of a website when the user launches the extension while viewing the website.

13. The community digital library system of claim 12, wherein the browser extension accepts user input regarding a submission of a web page or portion of a web page into the communities index.

14. The community digital library system of claim 13, wherein browser extension allows users to add submissions to the communities and continuously update their content to reflect utility of the submissions with response to a submission being added and previous submissions in the communities.

15. The community digital library system of claim 1, wherein the agent is an open-source generative language model and provides the user interface with a “Search the Web” link and a “Generate Answer” link.

16. The community digital library system of claim 15, wherein the agent provides a user with a list of recommended submissions related to the user's selected context on a web page being viewed and grouped by what has been submitted by the user or submitted by another member of the communities.

17. The community digital library system of claim 1, wherein the agent accesses stored information in the communities index database about users, including submissions and user behaviors, to personalize search results and generated questions for each of the users.

18. A browser extension for a community digital library system, the browser extension, comprising:
user interfaces to add to and access a communities index database that hosts one or more communities, wherein the communities index database indexes information with user input regarding the information for each of the one or more communities;
the user interfaces comprising a search interface to the communities index database; and
access to an agent configured to access the information and user input indexed in the communities index database and provide a search function to members of each of the one or more communities.

19. The browser extension for a community digital library system of claim 18, wherein the agent is an open-source generative language model and provides the user interface with a “Search the Web” link and a “Generate Answer” link.

20. The browser extension for a community digital library system of claim 19, wherein the agent provides a user with a list of recommended submissions related to the user's selected context on a web page being viewed and grouped by what has been submitted by the user or submitted by another member of the communities
